(19) United States
(12) Patent Application Publication
(10) Pub. No.: US 2012/0128819 A1
(43) Pub. Date: May 24, 2012

(54) Method of Improving Pre-Baked Dough Products

(76) Inventors: Kellie M. Fischer, Ham Lake, MN (US); Mike Freeman, Robbindale, MN (US)

(21) Appl. No.: 13/300,726

(22) Filed: Nov. 21, 2011

Related U.S. Application Data
(60) Provisional application No. 61/416,554, filed on Nov. 23, 2010.

(51) Int. Cl. A21D 13/08; A21D 15/04; A21D 8/02; A21D 15/02; A21D 8/04

(52) U.S. Cl. 426/19; 426/496; 426/18; 426/549

(57) ABSTRACT

A method of making a prebaked biscuit product is described. This method includes preparing a dough containing pectin, baking the dough to make a biscuit product, freezing or refrigerating the biscuit product to make a refrigerated or frozen biscuit product, and heating the refrigerated or frozen biscuit product to make a prebaked biscuit product having an improved texture in comparison to a corresponding prebaked biscuit product made without pectin.

### CROSS-REFERENCE TO RELATED APPLICATIONS

This application claims the benefit of priority under 35 U.S.C. 119(e)(1) of a provisional patent application Ser. No. 61/416,554, filed, Nov. 23, 2010, which is incorporated herein by reference in its entity.

### TECHNICAL FIELD

The invention relates to the use of pectin in dough to prepare baked dough products. The invention is directed to the use of pectin in chemically leavened non-laminated dough, such as biscuit dough, to improve the baked product texture and performance, especially, after reheating.

Prior uses of pectin and pectin/enzyme blends in baked goods have been specifically related to yeast-leavened products like frozen, retarded, pre-proofed and par-baked bread doughs, as described in U.S. Pat. No. 5,447,738: WO Publication No. 200178514; and EP No. 0542353 A1. Technical articles describing the use of pectin in yeast-leavened products include: European Food Research and Technology volume 218, “Impact of microbial transglutaminase on the viscoelastic properties of formulated bread doughs.” and Herbstreith & Fox Technical Application Information: “Pectin prolongs the Fresh-Keeping of Bread Rolls and Dough.”

### BACKGROUND

Biscuits are an extremely popular food product and have been a staple part of a traditional meal for centuries. Biscuits generally have a very tender, soft, moist and fluffy interior crumb texture, and a somewhat firmer but still tender crust. It is difficult to maintain the texture of biscuits after they are baked or reheated. This is especially difficult when the reheated, prebaked biscuits are manipulated and/or cooled prior to consumption. In restaurants and other retail food outlets, biscuits may be kept in a heating device for several hours after baking before they are served to consumers. Many times baked biscuits are further manipulated to create a biscuit sandwich or for other applications. These finished products then may or may not go back into or under a heating device prior to being served. An average amount of time for a biscuit to be in or under a heating device prior to serving is around two hours, and a typical temperature of a heating device is approximately 150° F. The time spent in or under a heating device can have a negative effect on the texture and appearance of biscuits. As prebaked biscuits cool outside of a heated holding unit, there are further negative impacts on biscuit texture and compressibility.

The invention is directed to a method of making a prebaked biscuit product, including preparing a dough containing pectin, baking the dough to make a biscuit product, freezing or refrigerating the biscuit product to make a refrigerated or frozen biscuit product, and heating the refrigerated or frozen biscuit product to make a prebaked biscuit product having an improved texture in comparison to a corresponding prebaked biscuit product made without pectin. The invention is also directed to a prebaked biscuit product made by this method.

As used herein, “prebaked” refers to a product which has been baked and then frozen or refrigerated prior to re-heating for consumption.

The foregoing has outlined the features and technical advantages of the invention in order that the detailed description of the invention that follows may be better understood. Additional features of the invention which form the subject of the claims of the invention will be described hereinafter. It should be appreciated by those skilled in the art that the specific embodiments disclosed may be readily utilized as a basis for modifying or developing other compositions for carrying out the same purposes of the invention. It should also be realized by those skilled in the art that such equivalent compositions do not depart from the spirit and scope of the invention as set forth in the appended claims. The novel features which are believed to be characteristic of the invention, both as to its composition, its chemical functionality, and the process for making the invention, together with further objects and advantages will be better understood from the following description when considered in connection with the accompanying figures. It is to be expressly understood, however, that each of the figures is provided for the purpose of illustration and description only and is not intended as a definition of the limits of the invention.

### BRIEF DESCRIPTION OF THE DRAWINGS

FIG. 1 a is a graph comparing the heights of Control, Pectin I and Pectin II biscuit products, and FIG. 1b is a graph comparing the baked specific volume of these biscuit products.

FIG. 2 is a graph comparing the compression values obtained for Control, Pectin I and Pectin II biscuit products.

FIGS. 3a-c are photographs of the cross section of Control, Pectin I and Pectin II biscuit products, comparing the baked heights and baked specific volumes of these products.

FIGS. 4a-c are micrographs of Control, Pectin I and Pectin II biscuit products with a 200 μm scale bar.

FIGS. 4d-f are micrographs of Control, Pectin I and Pectin II biscuit products with a 50 μm scale bar.

FIG. 5a is a graph comparing the first-bite hardness of Control, Bridgford® Prebaked and Pectin II biscuit products.

FIG. 5b is a graph comparing the springiness of Control, Bridgford® Prebaked and Pectin II biscuit products.

FIG. 6 is a graph comparing compression values obtained for a Control biscuit product and a variety of other biscuit products containing different types of pectin.

### DETAILED DESCRIPTION OF THE PREFERRED EMBODIMENTS

Prebaked biscuits made from pectin-containing biscuit dough have improved after-bake holding stability and textural properties, such as softness, volume and compressibility, as compared to biscuits made without pectin. The improvement in biscuit texture is still substantially discernible even after the prebaked biscuits have been held for several hours in a heating device or allowed to cool.

Pectin is a plant-derived polysaccharide including 1,4-linked α-D-galactouronic acid residues. In nature, approximately 80% of the galactouronic acid residues are esterified with methanol. During pectin extraction from plants, up to approximately 72% of the galactouronic acid residues in pectin are esterified. The degree of esterification of pectin may be increased after extraction, through the chemical esterification of pectin with methanol. Pectins with a degree of esterification up to about 85-90% may be produced through chemical esterification. The degree of esterification of pectin may also be decreased after extraction. Altering the degree of esterification changes the functionality of the pectin. Pectin with a degree of esterification of 50% or greater is referred to as “high ester pectin”. Pectin with a degree of esterification of less than 50% is referred to as “low ester pectin”. In the Examples that follow, pectins having a degree of esterification of 30%, 60% and 72% were used to compare the functionality of each type of pectin in a biscuit product. These pectins are commercially available from CP Kelco U.S., Inc., Atlanta, Ga., United States.

The amount of pectin added to a biscuit dough as described herein may be in the range of from about 0.01% to about 1.5%, or from about 0.05% to about 1%, or from about 0.15% to about 0.3% by weight of the dough. All percentages used herein refer to percent by total weight of the dough unless indicated otherwise. Pectin in biscuit dough appears to be much more functional at these lower levels than typical pectin levels recommended for bread and rolls, i.e. 0.6-1.2%. Higher levels of pectin in biscuit dough tend to have a negative effect on height and compressibility. It was unexpectedly discovered that there is an optimum range of pectin in a biscuit dough formula to control moisture without adding too much viscosity or structure that would increase baked biscuit firmness.

Adding pectin to biscuit dough yields an improvement in biscuit texture. The improvement in texture observed by using the pectin is particularly well-demonstrated in a prebaked biscuit made from biscuit dough containing a chemical leavening system. One example of a suitable pectin is as GENU® type BIG which is commercially available from CP Kelco U.S., Inc., Atlanta, Ga., United States.

It was also found that a pectin/enzyme blend can be used to improve biscuit texture. One example of a suitable pectin/enzyme blend is a blend of approximately 60% pectin, approximately 39% sucrose, and less than 1% each of: cellulose; xylanase eno 4,4; and alpha-amylase (fungal). This pectin/enzyme blend is commercially available from CP Kelco U.S., Inc., Atlanta, Ga., United States, as GENU® type X-601-03.

Other hydrocolloids or enzymes may be used as an alternative to or in combination with pectin. Useful hydrocolloids may include xanthan gum, hydroxypropyl methylcellulose (HPMC), gelatin, alginates such as sodium alginate and propylene glycol alginate (PGA), and the like.

Leavening agents, such as chemical leavening agents and yeast leavening agents, are used in the dough. Acidic leavening agents that may be useful include those generally known in the dough and bread-making arts. Acidic leavening agents may be encapsulated. Examples of acidic leavening agents include sodium aluminum phosphate (SALP), sodium acid pyrophosphate (SAPP), monosodium phosphate, monocalcium phosphate (MCP), anhydrous monocalcium phosphate (AMCP), dicalcium phosphate dehydrate (DCPD), and calcium acid pyrophosphate (CAPP), among others.

Useful basic chemical leavening agents are known in the dough and bread-making arts, and include sodium bicarbonate (baking soda), potassium bicarbonate, ammonium bicarbonate, and the like. Basic chemical leavening agents may also include encapsulated leavening agents.

Other ingredients can be added to the dough, such as: flavorings, including salt, sugar and dairy ingredients; wheat protein isolate; and emulsifiers. Examples of emulsifiers that may be used include, but are not limited to, diacetyl tartaric acid ester of monoglyceride (DATEM), sodium stearoyl lactylate (SSL), lecithin, and mono- and di-glycerides.

A general formula for a biscuit dough includes about 25-50% flour, about 25-50% water, and about 10-25% fat or oil, with the balance made up of leavening agents, emulsifiers, flavorings and other ingredients, each at a level of less than about 2% by weight of the dough.

Properties of a variety of biscuits were analyzed as discussed below. The “Control” biscuits were made from the general formula described above. The pectin containing biscuit formulas were made by adding an amount of pectin to the Control dough formula as shown in Table 1, adding some water, and reducing the amount of flour in the Control dough formula by the same amount. Effects of added water alone do not contribute to the texture improvement seen as it was observed that the baked analytical moisture levels of Control and pectin-containing biscuits with added water were the same.

TABLE 1
Dough Formulas

| | | % of | % added |
|---|---|---|---|
| | Pectin Variables | formula | water |
| Pectin I | pectin only | 0.20% | 1% |
| Pectin II | pectin/enzyme blend | 0.20% | 1% |

Biscuits were made by mixing the dough ingredients using a bar mixer and RONDO® sheeter. The dough was divided into pieces, and the dough pieces were baked at 375° F. for 20 minutes to make baked biscuits. The baked biscuits were then frozen. The frozen prebaked biscuits were then reheated to a temperature of about 155° F. prior to testing. Some testing was conducted on reheated, cooled biscuit product as well.

Various tests were conducted on the biscuits. A combination of analytical and sensory data were utilized to conduct extensive ingredient screening designs and ultimately on optimized formulas. Optimized formulas were successfully scaled up at a manufacturing facility and performance confirmed through additional testing.

Baked height and BSV (baked specific volumes) were measured using a TexVol Instruments BVM-L370 apparatus.

Compression tests were conducted by measuring the peak force required, in g/mm, to push through the baked product to a distance of 10.5 mm. The compression peak force was measured using a texture analyzer with a disc size of 100 mm. In general, a lower compression value indicates a desirably softer texture. Compression data was generated on a Texture Analyzer Model TA-X2i using both a 100 mm diameter platen probe and a 25 mm cylinder probe, using 12 mm distance and 5 mm/sec speed settings.

### Example 1

### Effect of Pectin on Biscuit Baked Height, Volume and Compression

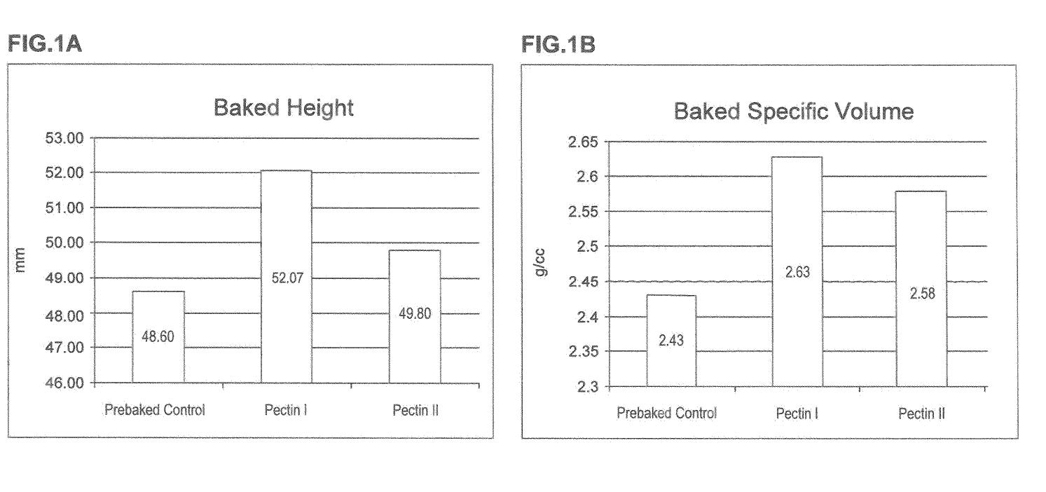

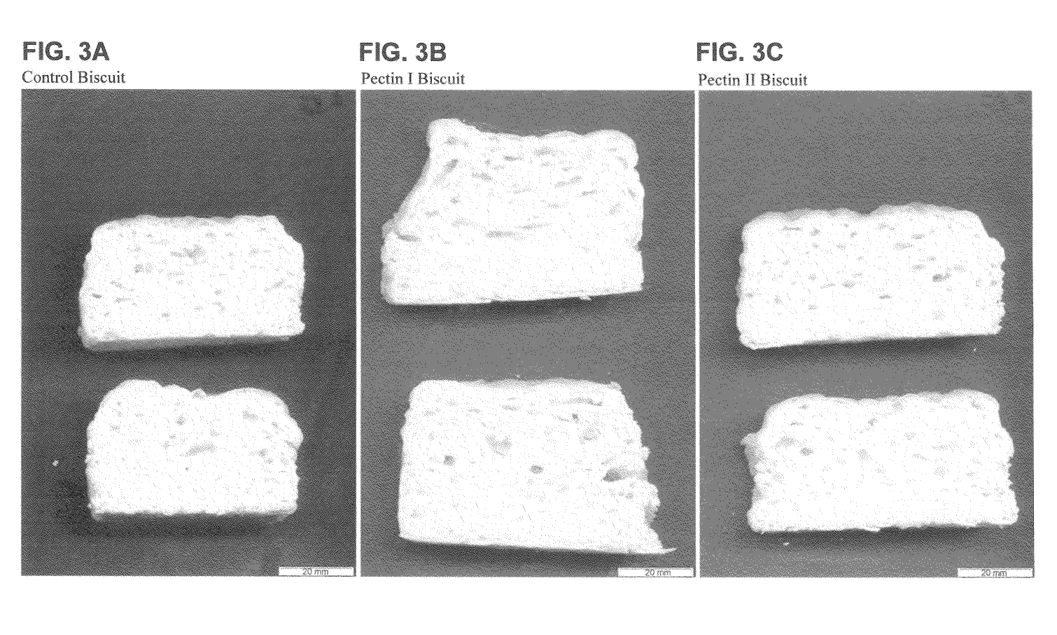

Doughs were prepared using a Control, and the Pectin I and Pectin II formulas set forth in Table 1. After baking, freezing, and reheating, the height, baked specific volume (BSV) and compression of the biscuit samples were measured. The height and baked specific volume results are graphed in FIGS. 1a and 1b and are pictured in FIGS. 3a-c.

For the biscuit formulas discussed above, an analysis of the effect of warming cabinet hold time on compression was also conducted. For this analysis, samples of biscuits made from each formula were placed in a 155° F. warming cabinet. One set of biscuits was in the warming cabinet for 30 minutes prior to testing, and, a second set of biscuits was in the warming cabinet for 60 minutes prior to testing, while a third set of biscuits was not placed in the warming cabinet prior to testing.

TABLE 2
Effect of Pectin on Baked Height, BSV and Compression

| | Height | BSV | Compression (in g/mm) | | |
|---|---|---|---|---|---|
| Formula | (in mm) | (in g/cc) | 0 min | 30 min | 60 min |
| Control | 48.60 | 2.43 | 5174 | 1892 | 1483 |
| Pectin I | 52.07 | 2.63 | 2315 | 818 | 1128 |
| % Difference | 7.14% | 8.23% | 55.26% | 56.77% | 23.94% |
| from Control | increase | increase | decrease | decrease | decrease |
| Pectin II | 49.80 | 2.58 | 2617 | 1245 | 1375 |
| % Difference | 2.47% | 6.17% | 49.42% | 34.20% | 7.28% |
| from Control | increase | increase | decrease | decrease | decrease |

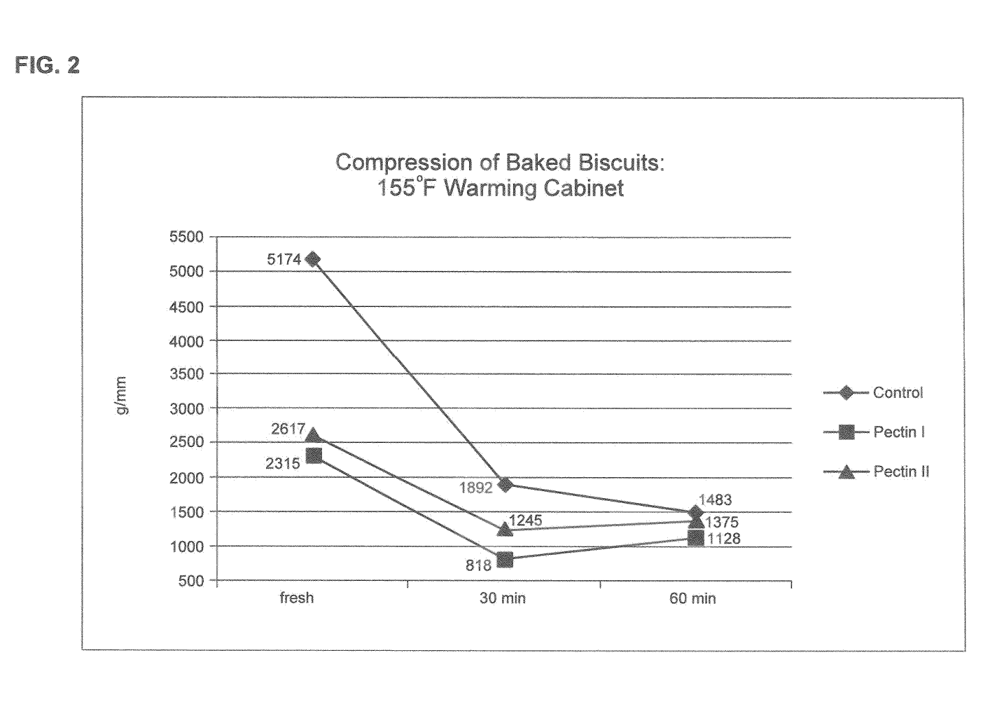

A comparison of the compression values for the Control, Pectin I, and Pectin II biscuits is shown in FIG. 2, and photographs of the cross sections of each of these biscuits are shown in FIGS. 3a-c. For these samples, the compression values were lower (softer) than the Control most dramatically with no hold time, indicating that the warming cabinet holding time generally resulted in a softer crust and softer crumb for all of the biscuit products. However, the Pectin I and Pectin II biscuits started out softer than the Control, so their desirably improved soft texture continued to remain softer than the Control biscuits over time in the warming cabinet. This improved texture also improves consistency of the consumer eating experience, since the textural variability when receiving a “fresh” product versus a “held” product is reduced.

### Example 2

### Microscopic Evaluation of Biscuit Attributes

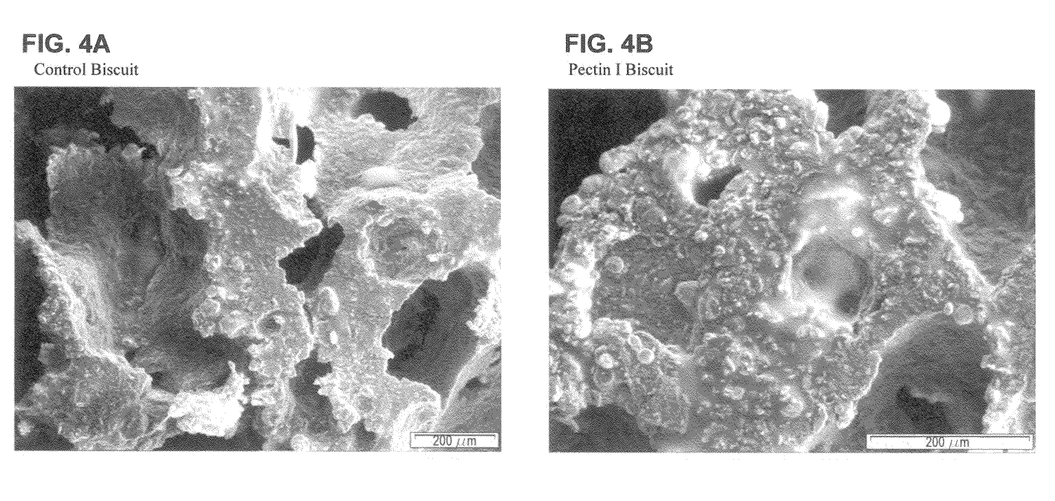

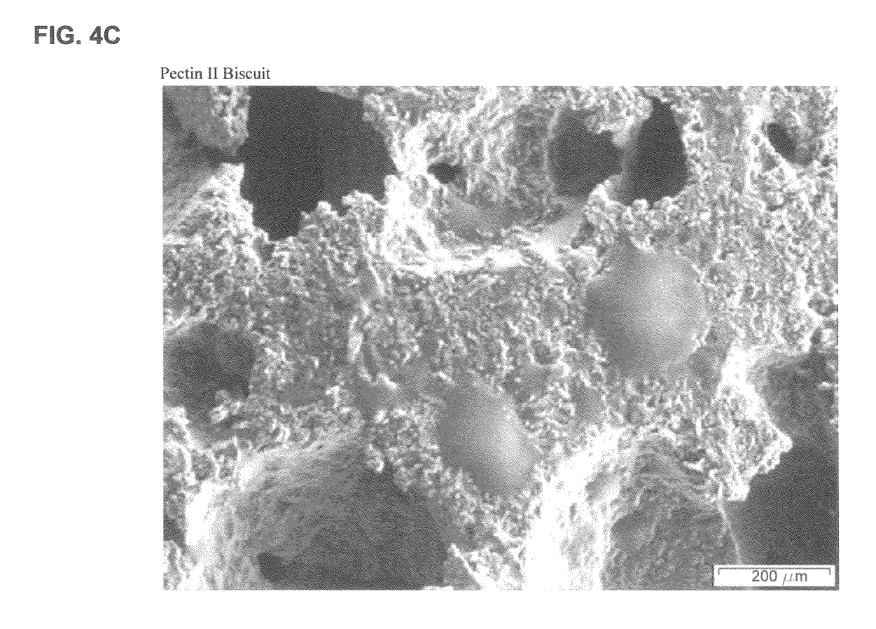

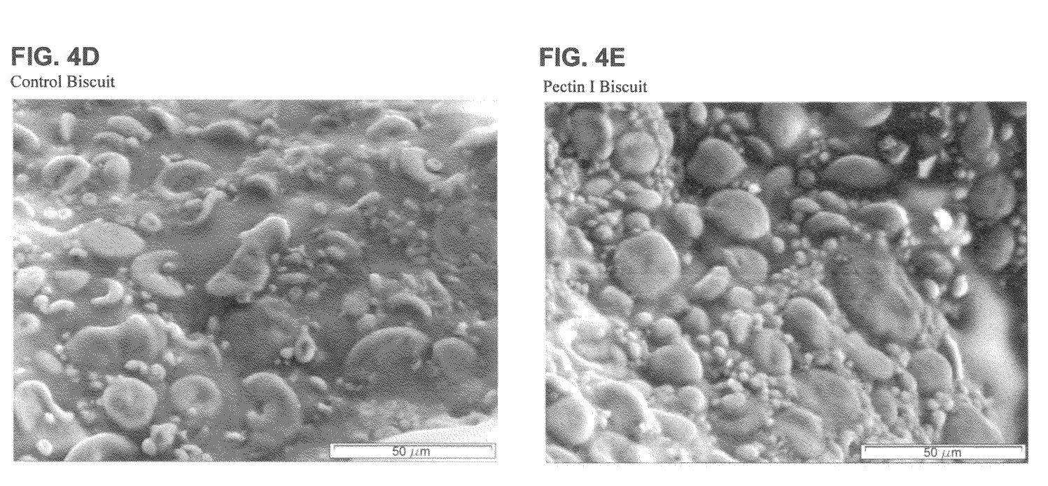

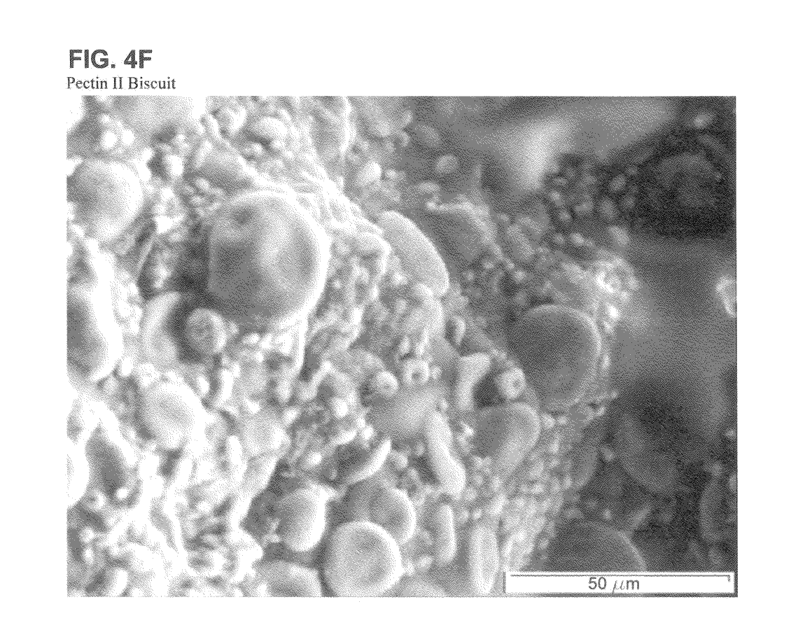

Samples of the Control biscuits, Pectin I biscuits and Pectin II biscuits were analyzed using scanning electron microscopy (SEM), and the micrographs are shown in FIGS. 4a-f While not intending to be bound by theory, pectin appears to be controlling the amount and distribution of moisture. This moisture control is important in protecting against staling as well as more evenly distributing the moisture, thereby not allowing the surface to become as dehydrated during baking as a Control product.

A comparison of the micrographs in FIGS. 4a-c showed that the starch granules were the most distinct in the micrographs of biscuits with pectin. The Control sample exhibits more of a glassy fracture face where starch is not as easily distinguished from the matrix. The pectin-containing biscuit formulas could function by slowing retrogradation of starch as water may be slightly less available to the starch for gelatinization. FIGS. 4d-f show the bubble interface of the Control, Pectin I and Pectin II biscuits. The bubble interface in the Control biscuit appears more “fluid”, which may be an indication that there is less moisture control in the Control biscuit than in the Pectin I and Pectin II biscuits.

It was unexpectedly discovered that at the optimum pectin levels described previously, it is possible to manage or control the moisture distribution and availability within the dough during baking, while at the same time substantially avoiding the firmness and other negative attributes associated with higher levels of pectin in a baked product. It is believed that by sequestering or hindering some of the dough moisture from being taken up by starch with the use of pectin, less starch gelatinization occurs during baking, without the concomitant viscosity buildup (and resulting baked product firmness) associated with higher pectin doughs. Less starch gelatinization results in slowing down the starch retrogradation rate in the baked product. The resulting baked product therefore has a softer texture, even upon reheating and cooling, than the Control product.

### Example 3

### Effect of Pectin on Sensory Attributes Related to Texture

Sensory attributes of the Control biscuit, the Pectin II biscuit, and a commercially available Bridgford® prebaked biscuit were analyzed. The Bridgford® biscuit is available from Bridgford Food Corporation, Anaheim, Calif. The following sensory attributes of each biscuit were analyzed by a trained Descriptive Analysis Panel using a 15 point scale: first-bite hardness, dissolvability, springiness, cohesiveness of mass, and initial cohesiveness. In general, biscuits having less first bite hardness and less springiness are preferred by consumers because these biscuits are perceived to have a better texture.

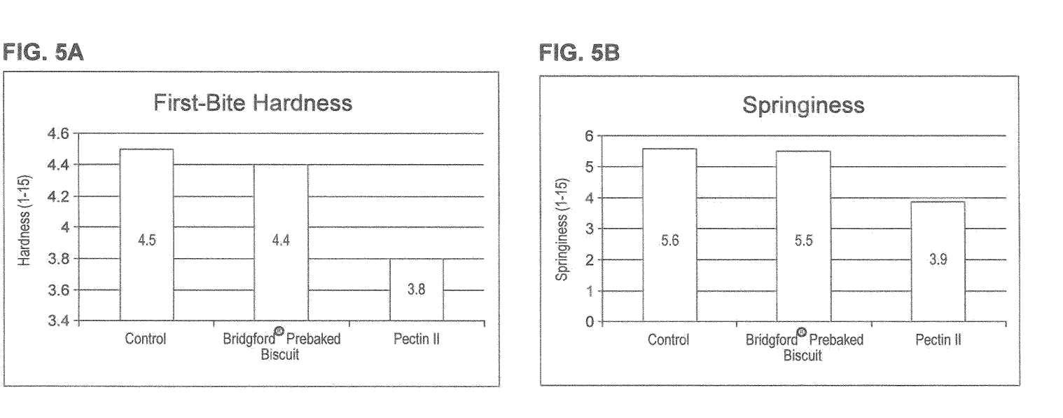

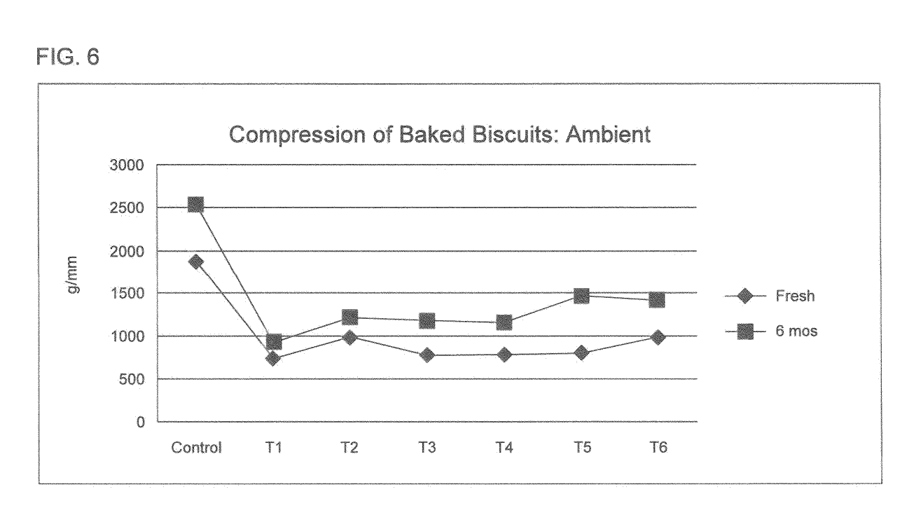

Prebaked biscuits were reheated in a Blodgett Convection Oven until they reached 140° F. and were allowed to cool for 15 minutes prior to evaluating. The results of these measurements are set forth in Table 3 and FIGS. 5a and 5b. Differences greater than or equal to 0.5 are meaningful. As shown by these data, the Pectin II biscuit performed better over each of the tested attributes that tend to correlate to a softer textured product as compared to the Control biscuit and the Bridgford® Prebaked Biscuit.

TABLE 3

| Formula | First-Bite Hardness | Springiness |
|---|---|---|
| Control | 4.5 | 5.6 |
| Bridgford ® Prebaked Biscuit | 4.4 | 5.5 |
| % Difference from Control | 2.2% decrease | 1.78% decrease |
| Pectin II | 3.8 | 3.9 |
| % Difference from Control | 15.5% decrease | 30.4% decrease |

### Example 4

### Effect of Different Pectin Types and Levels on Compression Over Shelf Life

Texture Analyzer firmness was conducted on samples with differing pectin types and levels. The analyses were done using the Texture Analyzer Model TA-X2i with a 25 mm probe on reheated biscuits that were completely cooled. The test was repeated at the end of frozen shelf life (6 months) to determine impact of pectin over shelf life. A biscuit sample was prepared using the Control formula described above. Additional samples were prepared with varying pectin types and levels listed in Table 4.

TABLE 4
Pectin Types and Levels

| Control | Pectin Type | Level |
|---|---|---|
| T1 | GENU ® type BIG | 0.02 |
| T2 | High ester, slow set | 0.02 |
| T3 | Low ester, amidated | 0.02 |
| T4 | GENU ® type BIG | 0.01 |
| T5 | High ester, slow set | 0.01 |
| T6 | Low ester, amidated | 0.01 |

There was not a significant difference in firmness measured among the six pectin-containing biscuits. However, all six of the pectin-containing biscuits had a significantly softer texture than the Control biscuit which was maintained over shelf life.

As described above, the prebaked pectin-containing biscuits made by the method of the invention have improved textural properties upon baking and reheating, and over time when held in a warming cabinet or other heating device, as compared to prebaked biscuits which do not contain added pectin. In particular, the reheated prebaked biscuits showed at least about a 2.0% increase in height and BSV over biscuits that did not contain pectin or a pectin/enzyme blend, and at least about a 35% decrease in initial compression test values in comparison with the control biscuits. Over time held in a warming cabinet, the biscuits made by the method of the invention showed at least about a 30% decrease in compression test values over a 30 minute holding time period, and at least about a 5% decrease in compression test values over a 60 minute time period, as compared to a control biscuit. All of these attributes contribute to the overall sensory perception that the biscuits made by the method of the invention have an improved texture as compared to control biscuits.

Although the invention and its advantages have been described in detail, it should be understood that various changes, substitutions and alterations can be made herein without departing from the spirit and scope of the invention as defined by the appended claims. Moreover, the scope of the application is not intended to be limited to the particular embodiments of the invention described in the specification. As one of ordinary skill in the art will readily appreciate from the disclosure of the invention, the compositions, processes, methods, and steps, presently existing or later to be developed that perform substantially the same function or achieve substantially the same result as the corresponding embodiments described herein may be utilized according to the invention.

What is claimed is:

1. A method of making a prebaked biscuit product comprising:
preparing a dough comprising pectin;
baking the dough to make a biscuit product;
freezing or refrigerating the biscuit product to make a refrigerated or frozen biscuit product; and
heating the refrigerated or frozen biscuit product to make a prebaked biscuit product having an improved texture in comparison to a corresponding prebaked biscuit product made without pectin.

2. The method of claim 1, wherein the dough further comprises an enzyme blend.

3. The method of claim 1, wherein the prebaked biscuit product has a baked specific volume greater than about 2.5 g/cc.

4. The method of claim 1, wherein the prebaked biscuit product has an initial compression test value of less than about 3000 g/mm.

5. The method of claim 1, wherein the prebaked biscuit product has a compression test value of less than about 1300 g/mm after 30 minutes in a warming cabinet.

6. The method of claim 1, wherein the prebaked biscuit product has a compression test value of less than about 1400 g/mm after 60 minutes in a warming cabinet.

7. The method of claim 1, wherein the prebaked biscuit product has at least about a 35% decrease in an initial compression test value in comparison with the corresponding prebaked biscuit product made without pectin.

8. The method of claim 1, wherein the prebaked biscuit product has at least about a 30% decrease in a compression test value taken after 30 minutes in a warming cabinet, in comparison with the corresponding prebaked biscuit product made without pectin.

9. The method of claim 1, wherein the prebaked biscuit product has at least about a 5% decrease in a compression test value taken after 60 minutes in a warming cabinet, in comparison with the corresponding prebaked biscuit product made without pectin.

10. The method of claim 1, wherein the heating step comprises holding the prebaked biscuit product at a temperature of about 155° F. for about 30 minutes.

11. The method of claim 1, wherein the heating step comprises holding the prebaked biscuit product at a temperature of about 155° F. for about 60 minutes.

12. The method of claim 1, wherein the dough further comprises a chemical leavening agent.

13. The method of claim 1, wherein the pectin is present in the dough in a range of from about 0.01% to about 1.5% by weight.

14. The method of claim 1, wherein the pectin is present in the dough in a range of from about 0.05% to about 1.0% by weight.

15. The method of claim 1, wherein the pectin is present in the dough in a range of from about 0.15% to about 0.3% by weight.

16. A prebaked biscuit product made by the method of claim 1.

17. The prebaked biscuit product of claim 16, wherein the prebaked biscuit product has at least about a 35% decrease in an initial compression test value in comparison with the corresponding prebaked biscuit product made without pectin.

18. The prebaked biscuit product of claim 16, wherein the prebaked biscuit product has at least about a 30% decrease in a compression test value taken after 30 minutes in a warming cabinet, in comparison with the corresponding prebaked biscuit product made without pectin.

19. The prebaked biscuit product of claim 16, wherein the prebaked biscuit product has at least about a 5% decrease in a compression test value taken after 60 minutes in a warming cabinet, in comparison with the corresponding prebaked biscuit product made without pectin.

20. The prebaked biscuit product of claim 16, wherein the prebaked biscuit product has an initial compression test value of less than about 3000 g/mm.
